(19) United States
(12) Patent Application Publication
(10) Pub. No.: US 2005/0138125 A1
(43) Pub. Date: Jun. 23, 2005

(54) Enterprise asset management by a third party expert system

(76) Inventors: Ethan Davis, Boise, ID (US); Hannah Recla, Ontario, OR (US)

Correspondence Address: ROBERT A. HUNTSMAN, 4466 S. RIVA RIDGE WAY, BOISE, ID, 83709, US

(21) Appl. No.: 10/741,121

(22) Filed: Dec. 19, 2003

(51) Int. Cl. G06F 15/16

(52) U.S. Cl. 709/206; 709/218

(57) ABSTRACT

A system and method to integrate an enterprise and an expert system in such a way that the expert system and the enterprise collaborate to both build and maintain the appropriate contact list and collect data regarding enterprise assets such as copiers, printers, and facsimile machines traditionally only available to the enterprise. Contacts by the expert system to the enterprise are minimized so that that enterprise is not unduly distracted by the important yet mundane task of collecting maintenance data. The expert system prepares and deploys an internet website having an associated datastore. An initial electronic message having a hypertext link to the expert system website is prepared by the expert system and delivered to a first enterprise contact. The electronic mail message is propagated thorough the enterprise, and additional enterprise contact information is reported by enterprise members using the hypertext link and the new enterprise contacts are recursively contacted with additional electronic messages. As targeted assets are located and information is gathered, the information is reported to the expert system through the web pages of the expert system website identified by hypertext links in the email, enabling the expert system to both efficiently collect and manage the data related to the targeted assets without significant foreknowledge of the enterprise infrastructure.

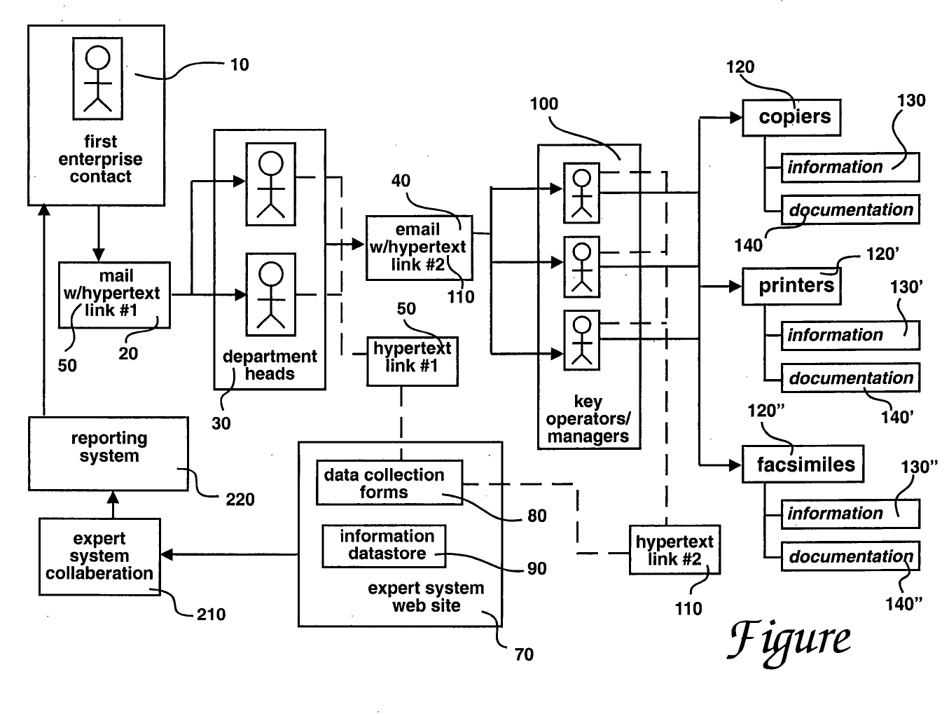

### FIELD OF THE INVENTION

This invention relates to a system and process for collecting maintenance and related information by an expert system from an enterprise relating to assets such as photocopiers, printers, and similar equipment. In particular, this invention integrates electronic mail, the world wide web, and manual data collections methods in a novel way to produce a highly efficient and accurate data collection system. The data thus gathered can them be made available to the enterprise and to the expert system in a form most suitable for the recipient.

Modern enterprises, both small and large, consist of a number of departments, each department in turn having a number of employees often at numerous physical locations. Office equipment, such as photocopiers and printers, can be deployed and moved frequently to meet the needs of the enterprise. Such equipment needs to be located and interrogated periodically for maintenance purposes. For example, many printer devices require manufacturer recommended services after a certain number of pages are printed. Often times, costs incurred by the use of the equipment is charged to various departments by usage, so it is necessary to monitor the usage on a regular basis so that the enterprise's internal billing and accounting requirements can be satisfied. This is often a problem because the physical location and associated responsible employees are fluid in a modern enterprise. The enterprise generally has its own processes and networks to locate such equipment, but the systems often are informal, and the location information and current assignments can often be obtained only by querying the managers and employees of the enterprise to locate the equipment and retrieve the necessary information.

### DESCRIPTION OF THE RELATED ART

Customarily, modern business have organizational charts, maintained by a human resources or similar group that identify employees and managers and their relationship to each other. Modern enterprises customarily maintain assets lists identifying the name and last known location of a particular assert. Some companies, particularly large ones, have internal departments that have individuals responsible for locating equipment for maintenance purposes and collecting the information when required. However, this system has serious drawbacks. First, it is expensive to have dedicated people performing asset management tasks, and thus it is desirable to outsource this job function to third party concerns that specialize in the requirement maintenance. Unfortunately, the third parties by their very nature are not generally well integrated into the enterprise, and thus lack the information needed to track the equipment. Some enterprises supply forms on the world-wide-web and ask their employees to identify asset information but such systems are flawed because the follow up necessary to obtain the information is not there in a static form system and the knowledge of who actually knows where a particular asset is often only exists in the head of an individual who often is not the personal formally responsible for the asset.

Systems exist for tracking assets within an enterprise, but lack the interaction and dynamic feedback necessary to actually locate equipment and retrieve necessary information in an efficient and timely manner. What is needed is a way to integrate an enterprise and an expert system in an efficient way so that required data can be collected on a periodic basis in an efficient way, without unduly burdening the enterprise.

### SUMMARY OF THE INVENTION

An object of this invention is to integrate an enterprise and an expert system in such a way that the expert system and the enterprise collaborate to both build and maintain the appropriate contact list and collect data traditionally only available to the enterprise. Contacts by the expert system to the enterprise are minimized so that that enterprise is not unduly distracted by the important yet mundane task of collecting maintenance data.

The present invention accomplishes this objective by teaching a novel system and method for performing such integration. Specifically, the present invention teaches dividing the task of collecting the information between the enterprise and expert system in a novel way as follows: The expert system prepares and deploys an internet website having an associated datastore. An initial electronic message (email) having a hypertext link to the expert system website is prepared by the expert system and delivered to a first enterprise contact. The email is then distributed by the enterprise contact to subordinates who recursively forward the email to their subordinates. The email contains a hypertext link to a web site where recipients can respond with either data or additional enterprise contact information. The expert system can then use the updated enterprise information to further distribute the email to employees of the enterprise. As targeted assets are located and information is gathered, the information is reported to the expert system through the web pages of the expert system website identified by hypertext links in the email. Thus the expert system is able to both collect and manage the data related to the targeted assets and is also able to provide expertise identifying missing information and helping the enterprise identify individuals that need to reply to complete the data collection. The enterprise then can contact the specific individuals need to complete the task—and only those individuals—so that the enterprise contacts are kept to a minimum.

Furthermore, in the case that a contact fails to respond, the expert system has sufficient information to trigger a follow up email back to that contact's superior, thus utilizing the enterprise's management clout to persuade contacts to complete their assignments and report in a timely manner.

### BRIEF DESCRIPTION OF THE DRAWING

The FIGURE shows a block diagram of relationship of the employees and asserts of the enterprise, the hypertext based electronic messages, and the website of the expert system according to the present invention.

### DETAILED DESCRIPTION OF A PREFERRED EMBODIMENT

The present invention is applicable to a number of different embodiments. In the preferred embodiment, the expert system provides expertise for both small and large enterprises deploying a number of copiers, printers and other document management office equipment. In the preferred embodiment, the expert system is not a manufacturer or vendor of copiers or related office equipment. Rather, the expert system of the preferred embodiment is a contracted third party that monitors equipment acquired by the enterprise from multiple vendors and is able to provide objective data and recommendations to the enterprise management based on accurate usage and maintenance data collected from the machines in an organized and efficient way.

In the preferred embodiment, the expert system includes an internet website and a corresponding computer having an information datastore. As information is collected, the results are maintained in the information datastore. Respondents are assigned an identification handle which can be use to associated response data with the corresponding respondent. In the preferred embodiments, certain targeted assets such as printers, copiers, and facsimile machines, need to be inventoried and usage and maintenance data needs to be collected from target assets. To accomplish this inventory and data collection task, the expert system prepares an email having an appropriate hypertext link to the internet website of the expert system. The email is forwarded to a previously identified first contact in the enterprise, typically a high ranking administrator of the enterprise and a customer of the expert system.

Referring to the FIGURE, the enterprise contains a number of targeted assets. In the preferred embodiment, the target assets are copiers 120, printers 120′, and facsimile machines 120″, and other related assets.

The expert system (not shown) sends an initial electronic mail (email) 20 to an enterprise contact 10, typically a high ranking administrator in the enterprise. The email includes a first world-wide-web hypertext link 50 that links to the data collection forms 80 of the expert system web site 70, as indicated in the FIGURE by the dotted line between the hypertext link 50 and the data collection forms 80 in the FIGURE. The email 20 is forwarded by the first enterprise contact 10 to each department head 30 of the enterprise. Each responding department head 30 will have the opportunity and in many cases, a mandate, to follow the hypertext link to the expert system where they will identify themselves and provide the expert system with enterprise specific information regard to who the appropriate contacts within the enterprise are.

The second email 40 contains a second hypertext link 110 that is also linked to the data collection forms 80 of the expert system web site. The second email 40 is transmitted to the key operators/managers 100 of the enterprise, which are known to the department heads 30 and generally will not be known by the expert system, thus this transmission effectively provides the expert system with an integrated communication path to the enterprise. The key operators/managers 100 typically will know where the devices sought are or know what individuals know or have responsibility for the target equipment. Thus the key operators/managers 100 will either personally visit the targeted assets or forward the second email 40 to their subordinates, recursively, until the second email 40 reaches a person in the enterprise who has the requisite knowledge and/or is responsible for the particular targeted asset 120, 120′, or 120″. Each asset has corresponding information 130, 130′, 130″ and/or documentation 140, 140′, 140″. The person within the enterprise responsible for each particular asset 120, 120′, or 120″ is instructed by the second email 40 as to what needs to be collected from the targets assets 120, 120′, 120″. As each person collects the information 130 and/or documentation 140 as specified by the second email 40, the person reports the data by clicking through the hypertext link 110 included in the second email 40. The link takes the enterprise contact to the data collection forms 80 of the expert system web site 70. The link also allows the responding person to identify and/or assign the requested action to another person in the enterprise by providing the name and contact information, including the email address, of the new delegate. This enables the expert system to automatically contact the new delegate by email without further interventions by the enterprise.

Two sample emails follows. For the purposes of the sample, the expert system is identified as CopierExpert. Ethan Evans manages the expert system for CopierExpert and the name of the enterprise is Acme, Inc. John Smith is the president of Acme Inc. The first enterprise contact of the enterprise is Janet Jones, who is a high level executive of Acme Inc. and has been identified by the enterprise as the first enterprise contact.

Below is a sample of the initial email sent to the first enterprise contact to be forwarded to high level subordinates:
Sample email #1:
   To: Department Heads:
   From: Janet Jones
   Subject: Copier Consultant
   We are attempting to consolidate our copier needs so that we can get better pricing on our machines by using our purchasing power. To do this, we need to perform a census on our machines. We have engaged a copier consultant, CopierExpert, to help us determine what we have and what we need. They will also assist us in auditing the maintenance of our machines and in making purchases and/or leases that have terms favorable to us rather than to the copier or leasing companies.
   To accomplish this, we are utilizing CopierExpert's on-line Information Collection System. The following link will take you to CopierExpert's web site and log you in, and the instructions for this system are listed there:
   http://www.copierexpert.com/ics/default.asp?wSx9=1234
   Please provide this information to CopierExpert by Dec. 31, 2003, or log in to CopierExpert's web site and assign someone else to do this so that the information can be gathered as quickly as possible.
   Obtaining good and reliable information up front will make this entire process go smoothly.
***end of sample email #1***
Sample email #2:
   From: “Ethan Evans? <support@copierexpert.com>
   To: janetjones@acme.com
   Sent: Friday, Sep. 22, 2003 1:22 PM
   Attach: memofrompresident.txt
   Subject: Transfer of responsibility by Ethan Evans
   Ethan Evans has identified you as the person responsible for the document production equipment at Acme, Inc. Acme, Inc. has contracted with CopierExpert to complete an evaluation of our current document production equipment. (For the scope of this project, please read the attached message from John Smith, President.) We are requesting your direct assistance in collecting and forwarding the data necessary to complete this analysis.
   Once you have read the attached message, please click on (or paste) the following link to your browser and follow the easy instructions listed there:
   http://www.copierexpert.com/default.asp?wSx9=312201
   Thank you in advance from your support team at CopierExpert!
***end of sample email #2***
***sample memo attachment from President John Smith***
   From the desk of the President John Smith:
   We are attempting to consolidate our copier needs so that we can get better pricing on our machines by using our purchasing power. To do that, we need to perform a census on our machines. We have engaged a copier consultant, CopierExpert, to help us determine what we have and what we need. They will also assist us in auditing the maintenance of our machines and in making purchases and/or leases that have terms favorable to us rather than to the copier or leasing companies.
   To accomplish this, we are utilizing CopierExpert's on-line information Collection system.
   Please provide this information to CopierExpert by Dec. 31, 2003, or log in to CopierExpert's web site and assign someone else to do this so that the necessary information can be gathered as quickly as possible.
   Obtaining good information up front will make this entire process go smoothly.
***end of sample memo***

In this example, the first email email 20 is forwarded to Janet Jones 10 who in turn forwards it to all of her subordinates 30 without any additional work by Ms. Jones 10. Those recipients who read email #1 and click on the hypertext link will be directed to a web page that collects contact information, confirms the responsibilities of the person responding, and will interrogate the responder for a referral for another contact if the responder is not personally responsible for the target asset. Any person referred by another person in the enterprise will be automatically sent an email like the sample email #2 above that prepared and sent by the expert system. This process will repeat recursively for a period of time until many, if not all, of the necessary contacts have been located and have responded with the appropriate machine information. The system can also report to the enterprise those individuals who have been identified but have not yet responded. This allows the enterprise to use its considerable influence to persuade all appropriate contacts to respond in a timely manner. After an appropriate period of time has lapsed, typically specified by the enterprise, the data collection effort is deemed closed. The collected information is stored by the expert system into the information datastore 90. The collected information is in the datastore 90 is made available to the expert system for further collaboration 210, and is also made available to a reporting system 220 which can organize the collected data into a number of useful reports that can then be made available to both the enterprise and the expert system for analysis with regarding to future purchasing and maintenance decisions.

This description of the preferred embodiment is provided by way of illustration, and should not be used to limit the scope of the inventions. One skilled in the art will be able to conceive of a number of other embodiments that would fall within the scope and the spirit of the invention described herein. The invention should only be limited by the claims as set forth below.

1. A system for collecting information for an expert system from an enterprise comprising:
an internet website, the website having an associated computer capable of interpreting website responses, the associated computer further enabled to send, receive, and store electronic message messages, the expert system having an information datastore capable of storing data collected from website responses, wherein the expert system:
identifies a first enterprise contact having a plurality of subordinates, identifies targeted assets of the enterprise, each targeted asset having associated targeted data,
identifies a first response time period,
formulates a first electronic message for distribution, the electronic message having a hypertext link to the website,
sends the first electronic message to the first enterprise contact,
wherein the first enterprise contact forwards the first electronic message to each subordinate,
wherein each subordinate optionally responds by activating the hypertext link within the first response time period, thereby transferring the subordinate to the website, wherein each responding subordinate uses the website to:
identify themselves,
acknowledge whether or not they are a proper respondant for the targeted data associated with at least one target asset,
transmit targeted data to the website,
wherein the expert system assigns an identification handle to each responding subordinate.

2. The system of claim 1 wherein the identification handle of the recipient of the first electronic email is included in the hypertext link, wherein the expert system automatically identifies respondents.

3. The system of claim 1 wherein the subordinate responds by entering the targeted data of the corresponding targeted asset using a form on the website.

4. The system of claim 1 wherein the subordinate responds by identifying a hardcopy document using a form on the website.

5. The system of claim 1 wherein the subordinate responds by identifying and uploading an electronic document using a form on the website.

6. The system of claim 1 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

7. The system of claim 2 wherein the subordinate responds by entering the targeted data of the corresponding targeted asset using a form on the website.

8. The system of claim 2 wherein the subordinate responds by identifying a hardcopy document using a form on the website.

9. The system of claim 2 wherein the subordinate responds by identifying and uploading an electronic document using a form on the website.

10. The system of claim 2 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

11. The system of claim 7 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

12. A method for collecting information for an expert system from an enterprise comprising the steps of:
associating an internet website with the expert system, the website having an associated computer capable of interpreting website responses, the associated computer further enabled to send, receive, and store electronic message messages,
the expert system having an information datastore capable of storing data collected from website responses,
identifying a first enterprise contact having a plurality of subordinates,
identifying targeted assets of the enterprise, each targeted asset having associated targeted data,
identifying a first response time period,
formulating a first electronic message for distribution, the electronic message having a hypertext link to the website,
sending the first electronic message to the first enterprise contact,
wherein the first enterprise contact forwards the first electronic message to each subordinate,
wherein each subordinate optionally responds by activating the hypertext link within the first response time period, thereby transferring the subordinate to the website, wherein each responding subordinate uses the website to:
identify themselves,
acknowledge whether or not they are a proper respondant for the targeted data associated with at least one target asset,
transmit targeted data to the website,
wherein the expert system assigns an identification handle to each responding subordinate.

13. The method of claim 12 wherein the identification handle of the recipient of the first electronic email is included in the hypertext link, wherein the expert system automatically identifies respondents.

14. The method of claim 12 wherein the subordinate responds by entering the targeted data of the corresponding targeted asset using a form on the website.

15. The method of claim 12 wherein the subordinate responds by identifying a hardcopy document using a form on the website.

16. The method of claim 12 wherein the subordinate responds by identifying and uploading an electronic document using a form on the website.

17. The method of claim 12 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

18. The method of claim 13 wherein the subordinate responds by entering the targeted data of the corresponding targeted asset using a form on the website.

19. The method of claim 13 wherein the subordinate responds by identifying a hardcopy document using a form on the website.

20. The method of claim 13 wherein the subordinate responds by identifying and uploading an electronic document using a form on the website.

21. The method of claim 13 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

22. The method of claim 18 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

23. A computer-readable medium for collecting information for an expert system from an enterprise comprising computer executable steps of:
associating an internet website with the expert system, the website having an associated computer capable of interpreting website responses, the associated computer further enabled to send, receive, and store electronic message messages,
the expert system having an information datastore capable of storing data collected from website responses,
identifying a first enterprise contact having a plurality of subordinates,
identifying targeted assets of the enterprise, each targeted asset having associated targeted data,
identifying a first response time period,
formulating a first electronic message for distribution, the electronic message having a hypertext link to the website,
sending the first electronic message to the first enterprise contact,
wherein the first enterprise contact forwards the first electronic message to each subordinate,
wherein each subordinate optionally responds by activating the hypertext link within the first response time period, thereby transferring the subordinate to the website, wherein each responding subordinate uses the website to:
identify themselves,
acknowledge whether or not they are a proper respondent for the targeted data associated with at least one target asset,
transmit targeted data to the website,
wherein the expert system assigns an identification handle to each responding subordinate.

24. The medium of claim 23 wherein the identification handle of the recipient of the first electronic email is included in the hypertext link, wherein the expert system automatically identifies respondents.

25. The medium of claim 23 wherein the subordinate responds by entering the targeted data of the corresponding targeted asset using a form on the website.

26. The medium of claim 23 wherein the subordinate responds by identifying a hardcopy document using a form on the website.

27. The medium of claim 23 wherein the subordinate responds by identifying and uploading an electronic document using a form on the website.

28. The medium of claim 23 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

29. The medium of claim 24 wherein the subordinate responds by entering the targeted data of the corresponding targeted asset using a form on the website.

30. The medium of claim 24 wherein the subordinate responds by identifying a hardcopy document using a form on the website.

31. The medium of claim 24 wherein the subordinate responds by identifying and uploading an electronic document using a form on the website.

32. The medium of claim 24 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.

33. The medium of claim 29 wherein the first subordinate provides contact information including an electronic message address for zero or second subordinates, the second subordinates are subordinates of the first subordinate,
wherein each second subordinate is either accountable for one or more targeted assets or has subordinates who are accountable for one or more target assets,
wherein each second subordinate is a subordinate of the first subordinate,
wherein the expert system:
records the contact information in persistent media,
assigns an identification handle to each responding second subordinate,
sends a second electronic message to each second subordinate, wherein each second subordinate recursively becomes a first subordinate, wherein the electronic message submission and corresponding responses propogate throughout the enterprise until the first time period has expired.
